(19) United States
(12) Patent Application Publication
(10) Pub. No.: US 2012/0244369 A1
(43) Pub. Date: Sep. 27, 2012

(54) COATINGS TO PREVENT BIOFOULING OF SURFACES

(75) Inventors: Christopher K. Ober, Ithaca, NY (US); Craig Jonathan Weinman, Mesa, AZ (US); Daewon Park, Greenwood Village, CO (US); Dale L. Handlin, Shelby, NC (US)

(73) Assignee: Cornell University, Ithaca, NY (US)

(21) Appl. No.: 13/403,554

(22) Filed: Feb. 23, 2012

Related U.S. Application Data
(60) Provisional application No. 61/446,242, filed on Feb. 24, 2011.

(51) Int. Cl. C09D 153/02; B05D 3/10; B32B 27/08; C08F 299/02

(52) U.S. Cl. 428/516; 525/276; 524/531; 427/341

(57) ABSTRACT

The invention provides novel compositions comprising one or more polymers, including a functional triblock copolymer and optionally a structural triblock copolymer and compositions that include such polymers. The functional triblock contains quaternized nitrogen anti-fouling functionality. The compositions can be used to prepare antimicrobial, antifouling coatings, for example, for medical, health, marine fouling, corrosion and general protein fouling resistance applications.

### CROSS-REFERENCE TO RELATED APPLICATIONS

This application claims the priority of U.S. provisional application Ser. No. 61/446,242, filed Feb. 24, 2011, which is incorporated herein by reference in its entirety.

### STATEMENT OF GOVERNMENT SUPPORT

This invention was made with government support under grant number WP-1454 from the Strategic Environmental Research and Development Program, and number N00014-02-1-0170 awarded by the Office of Naval Research. The U.S. government has certain rights in the invention.

### BACKGROUND

Suppression of the growth of microbes on surfaces is beneficial for a wide range of applications. In the medical field, a large number of infections are caused by microbial contamination of catheters and other devices introduced into the body both during short term surgical procedures and during longer treatments. Similarly, the growth of microbes on surfaces in ventilation systems, membrane systems and surfaces subject to frequent human contact such as medical instruments, grips, door handles, etc., can spread infection from human contact with these contaminated surfaces. Microbes are also responsible for the early stages of biofouling, which can occur in a wide array of environments such as inside the body or on objects in the marine environment such as ships' hulls, lights, sensors, and water intakes and outfalls. A common way of preventing microbial growth is the use of antimicrobial cleaning solutions containing alcohol, bleach or other agents. While cleaning solutions are effective for short periods of time, they require repeated application for effect. In other applications, the use of films or coatings containing antimicrobial leachable toxins such as silver and other metal and/or organic based biocides. Coatings containing leachable, toxic ingredients are effective, but many traditional biocides containing metal-derived biocides last only until the active ingredient is depleted and suffer from continuously variable effectiveness as the concentration of active ingredient declines. Such toxic antimicrobial agents have been linked to harmful effects on non-target organisms and the environment; consequently, both social and regulatory forces are imposing increasingly restrictive constrains on their use. Antifouling paints containing tin and copper biocides are currently used because they are effective against most forms of marine biofouling. Many of these biocidal organometallic compounds are environmentally persistent and can cause damage to the ecosystem and enter the food chain. Most countries around the world are adopting measures to limit or ban the presence of tributyltin antifoulants on vessel hulls, and copper-based coatings are expected to face similar restrictions in the near future.

A non-toxic, non-leaching coating with persistent antimicrobial characteristics that addresses issues of bioactive agent endurance and stability and meet industrial/commercial and regulatory requirements for bio-resistant surfaces has long been sought. Efficient placement of the active agent at the surface and the ability of the surface to heal itself after minor damage are highly desirable.

### SUMMARY

The coating compositions disclosed herein comprise one or more functional triblock copolymers with antimicrobial activity and, optionally, one or more triblock copolymers adapted as either a base layer to improve properties or as a matrix blended with a minority of the functional triblock copolymer. An optional adhesion layer or coupling agent can be present that is adapted to bond the functional triblock copolymer and/or triblock copolymer to a surface. Various embodiments of adhesion layers will vary according to the type of surface to be coated. Processes for preparing and methods of use of the disclosed compositions are also provided. A purpose of the functional triblock copolymer is to act as a non-leaching, non-toxic antimicrobial agent to prevent infection or fouling of surfaces by airborne or liquid-borne microbes.

The nonfunctional base or matrix triblock copolymer(s) can serve several purposes: to provide the desired mechanical properties of the coating such as modulus, hardness, tear resistance and scratch and mar resistance; to provide an even distribution of the functional polymer(s) throughout the coating by templating its structure on the nano-scale; and to aid in the processing the functional triblock copolymer. The functional triblock copolymer can be chosen from a range of ABC bock copolymers. In one preferred example the functional triblock copolymer can be a polystyrene-block-poly(ethylene-ran-butylene)-block-polyisoprene ABC triblock copolymer, modified by functionalization of the polyisoprene block with quaternary ammonium side chains, and optionally with other side chains such as hydrophilic, hydrophobic, and amphiphilic side chains. The functional polymer of the instant invention includes a polymer comprising at least three blocks, the first block comprising poly(styrene), the second block comprising a random arrangement of poly(ethylene) and poly(butylene) or poly(propylene), and a third block comprising functionalized poly(isoprene). The repeating units of the functionalized poly(isoprene) block contain substituents R^{a} and R^{b}, where R^{a} is a hydroxyl group and R^{b} is a hetero atom linked side chain. The positions of R^{a} and R^{b} are interchangeable within one isoprene unit. At least some of the heteroatom linked side chains R^{b} contain a tertiary amino group, wherein at least 10% of the tertiary amino groups are quaternized with one or more quaternizing groups selected from the set consisting of:

(—CH₂)ₓ(—CF₂)_{y}—F wherein each x and y are independently 1 to 12,

(C₁-C₃₀) perfluoroalkyl groups,

(C₁-C₃₀) alkyl groups,

perfluoroalkyl group that contains one or more ethylene glycol groups,

alkyl group that contains one or more ethylene glycol groups, and

polydimethyl siloxane groups of molecular weight of <2,000,

and wherein other R^{b} groups can optionally further be chosen from one or more of the set consisting of the following polar, nonpolar and amphiphilic groups:

XCH₂CH₂ (OCH₂CH₂)ₙOCH₃ wherein each n is independently 1-16,

X(CH₂)ₓ(CF₂)_{y}F wherein each x and y are independently 2-16,

XCH₂CH₂ (OCH₂CH₂)_{q}(CF₂CF₂)ᵣF wherein each q is independently 0 to about 25 and each r is independently 0 to about 18,

XCH₂CH₂ (OCH₂OCH₂)ₙOC₆H₄(CH₂)ₙCH₃ wherein each n is independently 5-16,

XCH₂OCH₂ (OCH₂OCH₂)ₙ(CH₂)ₙ CH₃ wherein each n is independently 7-16, and

XCH₂OCH₂ (OCH₂OCH₂)ₙ(CH₂)₃Si(CH₃)(OSi(CH₃)₃)₂, wherein each n is independently 7-16; wherein X is a hetero atom.

In various embodiments, greater than 20% of the side chains R^{b} contain a tertiary amine group, more preferably greater than 50% of the side chains R^{b} contain a tertiary amine group. At least 10% of the proportion of tertiary amine groups is quaternized.

In various embodiments, the poly(styrene) block of the polymers described herein can have a molecular weight of about 4,000 to about 12,000, the poly(ethylene) random poly(butylene) block can have a molecular weight of about 15,000 to about 100,000, and the functionalized poly(isoprene) block can have derived from a poly(isoprene) block of a molecular weight of about 5,000 to about 25,000.

In various embodiments, the invention also provides a polymer comprising formula I:

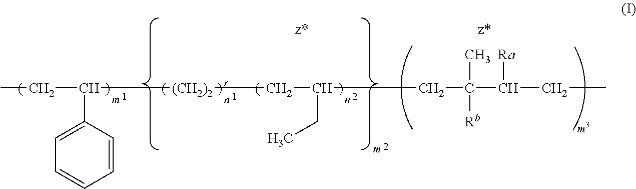

wherein

blocks m¹, m², and m³ can be disposed in any sequence;

a degree of polymerization of block m¹ is about 50 to about 120;

units n¹ and n² are selected so that block m² has a molecular weight of about 15,000 to about 100,000;

a degree of polymerization of block m³ is about 75 to about 375;

r indicates that the arrangement of individual n¹ and n² units within block m² is random;

z* indicates that the orientation of individual n² units, and units comprised by block m³, are reversible such that the ethyl side group may reside on either carbon of the n² unit, and R^{a} and R^{b} may reside on either of the internal carbons of each unit of the m³ block;

in the units of block m³, R^{a} is —OH and at least some of R^{b} within block m³ contains a tertiary amino group wherein at least 10% of said tertiary amino groups are quaternized with one or more of quaternizing groups selected from the set consisting of:

(—CH₂)ₓ(—CF₂)_{y}—F wherein each x and y are independently 1 to 12,

(C₁-C₃₀) perfluoroalkyl groups,

(C₁-C₃₀) alkyl groups,

perfluoroalkyl group that contains one or more ethylene glycol groups,

alkyl group that contains one or more ethylene glycol groups, and

polydimethyl siloxane groups of molecular weight of <2,000;

and,

wherein remaining R^{b} within block m³ comprises one or more polar, nonpolar and amphiphilic groups selected from the set consisting of:

XCH₂CH₂ (OCH₂CH₂)ₙOCH₃ wherein each n is independently 1-16,

X(CH₂)ₓ(CF₂)_{y}F wherein each x and y are independently 2-16,

XCH₂CH₂ (OCH₂CH₂)_{q}(CF₂CF₂)ᵣF wherein each q is independently 0 to about 25 and each r is independently 0 to about 18,

XCH₂CH₂ (OCH₂OCH₂)ₙOC₆H₄(CH₂)ₙCH₃ wherein each n is independently 5-16,

XCH₂OCH₂ (OCH₂OCH₂)ₙ(CH₂)ₙ CH₃ wherein each n is independently 7-16, and

XCH₂OCH₂ (OCH₂OCH₂)ₙ(CH₂)₃Si(CH₃)(OSi(CH₃)₃)₂, wherein each n is independently 7-16; wherein X is a hetero atom.

In each individual unit of block m³, R^{a} is —OH and at least some of R^{b} contains a tertiary amine group wherein at least 10% of the tertiary amine groups are quaternized with one or a combination of the group of quaternizing groups mentioned above. In various embodiments, at least 50% of the tertiary amine groups are quaternized. In various embodiments, the counterions to the quaternized amine groups can be a halide, such as chloride. The counterion can arise from use of a halide, e.g., chloride, form of the quaternizing group in preparation of the quaternized polymer of the invention.

The remaining R^{b} groups comprise polar, nonpolar or amphiphilic chains as are described above. In various embodiments, at least 1% of the R^{b} groups are one or a combination of the polar, non-polar or amphiphilic groups described above. In other embodiments, at least about 5%, about 10%, about 20%, or about 50% of the R^{b} groups are one or a combination of the polar, non-polar or amphiphilic groups described above.

In applications where the coatings will be used to prevent biofouling such as on a medical device, submerged or floating marine structure, vessel, or device, industrial platform, diagnostic or sensory apparatus, or any other bioresistant surface, the functional triblock copolymer may be an amphiphilic polymer such as those described in International Application No. PCT/US2009/001373, incorporated herein by reference. Such an amphiphilic polymer will have a functional block containing two types of functional groups: a nonpolar segment, for example a partially fluorinated chain, and a polar segment, for example a water soluble chain such as polyethylene glycol (PEG) in addition to the quaternized groups. The other two blocks of the amphiphilic polymer will be designed to compatibilize the polymer on the nano-scale with the matrix polymer.

An outstanding feature of these inventive compositions is that a small amount of functional polymer, the minor phase, can be used to have a significant impact on surface properties while mechanical properties are provided by an entirely different polymer composition, the matrix phase. Further since the functional polymer is distributed throughout the matrix polymer, any fresh surfaces which may be made by wear or damage will be covered by the functional polymer without reapplication or other repair process.

Surfaces should be considered as the two dimensional boundary between the blend and the environment. Such boundaries can be flat or curved and the two dimensional boundaries can be arranged in three dimensional structures, resulting in surface topologies required for the particular application. Simple topologies include flat surfaces such as found in industrial and domestic applications, and sheets and films. Complex topologies include micro-patterned surfaces, such as “shark skin”, pores, such as in porous membranes, channels, such as in non-porous membranes, threads, fibers, including fibers that form non-woven materials.

One function for the coating can be to provide a scaffold for attachment of bio-molecules by physical adsorption, physical entrapment, and covalent immobilization. In some cases these surfaces will present chemical or biological functionalities in distinct geometrical patterns. In some cases it is a requirement for those bio-molecules to be spatially distributed on the surface to accommodate the spatial requirements for the substrate they act on. In other cases it is a requirement for the bio-molecules to be spatially segregated from each other in order to achieve high activity and stability. The active sites of an enzyme, for instance, typically consist of a set of amino acid residues in a specific geometry, which governs its catalytic activity. In order to maintain their particular catalytic activity, these small interactive sites need to be retained in a precise position even after adhering to a solid surface. Additionally, the orientation of active sites with respect to solid supports may influence protein activity since the presence of solid supports can physically block accessible pathways to active sites. The block co-polymer matrix provides that spatial arrangement through its nano-structure, which is the result of the specific dimensions of the individual blocks of the block co-polymer.

Attached bio-molecules are useful in adhesive surfaces, biomaterials, bio-compatible surfaces, bioactive materials, bio-resistant surfaces, bio-electronics, biochips, bio-separations, bio-recognition probes, biological labeling, bio-composites, drug and gene delivery systems, diagnostics, dynamically switchable bio-interfaces, immobilization surfaces, membrane separations, medical devices, packaging, sensors, tissue engineering, tissue repair and regenerative medicine. Furthermore such attached bio-molecules can be used in bio-catalysis, bio-transformation, and bio-catalytic materials. Furthermore such attached bio-molecules can be used in anti-fouling coatings, anti-microbial coatings, bio-fouling resistant materials, bio-adhesion promoting materials, bio-compatible materials, bio-composites.

Another function of the coating can be to provide a scaffold for attachment of nano-particles. Those include nano-tubes, nano-sheets, nano-porous materials, such as single-walled nano-tubes, multi-walled nano-tubes, gold nano-particles and other metallic, semi-conducting, or metal oxide nano-particles, quantum dots and functionalized silica.

### BRIEF DESCRIPTION OF THE DRAWINGS

For the detailed description of the invention references will be made to the accompanying drawings in which:

FIG. 1 shows an example of a synthetic route for compositions of the invention.

FIG. 2 shows control and two test slides, each coated with a composition of the invention, then sprayed with aqueous suspensions of S. aureus. The sprayed surfaces were covered by molten agar-containing TSB (1.5% w/v of agar), allowed to solidify and then incubated at 37° C. overnight. The number of bacterial colonies was counted using a colony counter. The mean value of bacterial colonies of S. aureus grown on plain glass slides after overnight incubation was ca. 125 colonies/cm². In contrast, no colonies formed on surfaces coated with SQTC-F8H6Br—H6Br, which indicates high antibacterial activity.

### DETAILED DESCRIPTION

### Definitions

Certain terms are used throughout the following descriptions and claims to refer to particular components of the present composition without any intention to distinguish between components that differ in name but not function.

In the following description and in the claims, the terms “including” and “comprising” are used in an open-ended fashion, thus should be interpreted to mean “including, but not limited to”.

The term “triblock copolymer” as used herein refers to a block copolymer having three principal blocks, any or all of which can be a homopolymer or can be a copolymer of two or more monomeric units. A triblock copolymer can also include one or more additional, minor blocks that do not influence its structure. A “block” refers to a domain composed of a single monomeric type. A “unit” is an individual monomeric unit, a plurality of which form a block. In various embodiments herein the blocks are designated m1, m2, and m3. Each block of a molecule has a degree of polymerization, or an average degree of polymerization in a bulk sample, wherein degree of polymerization refers to the number of monomeric or repeating units present in the block.

The term QAC refers to quaternary ammonium. Several acronyms are used; another is QAUT. Any acronym that starts with Q in this context refers to quaternary ammonium—so quaternary ammonium polymer, quaternary ammonium chain, etc. The “QAT version” refers to the type of QAT polymer being tested (either fluorinated or non-fluorinated, the non-fluorinated version is that same as the “hydrocarbon” QAT). The “QAT polymer” column shows the bacterial colonies growing on the QAT polymer used in that experiment. So one compares the number of colonies growing on the QAT polymer with the number of colonies growing on the SEBS control. The controls are a SEBS coated slide which have no QAT surface, and a sodium azide slide. Bacteria will not grow on sodium azide, so it is used as the negative control.

Herein the term “nano-scale” is meant to refer to sizes of approximately one nanometer up to less than one micron in largest dimension.

The term “non-toxic” as used herein refers to a lack of toxicity to higher organisms such as humans, and does not encompass antimicrobial bioactivity.

A “tertiary amino group” as used herein refers to a group containing a basic nitrogen atom bearing three carbon-based substituents, provided that the nitrogen atom of the tertiary amino group may be quaterized, i.e., bearing a fourth carbon-based substituent and a positive charge on the nitrogen atom. For example, a copolymer side chain formed by incorporation of 3-(dimethylamino)-1-propylamine by reaction with an epoxidized isoprenyl unit incorporates the structure [polymer-NH—CH₂CH₂N(CH₃)₂]. The nitrogen atom bearing the two methyl groups is a tertiary amino group. However, within the meaning herein, a quaternized form of this subunit, e.g. as could be formed by reaction with an alkylating agent such as hexyl bromide, of the structure [polymer-NH—CH₂CH₂N⁺ (hexyl)(CH₃)₂], is a polymer also bearing a tertiary amino group within the meaning herein. When a tertiary amino group is quaternized, the positive charge on the nitrogen atom requires the presence of a negatively charged counterion. For example, the counterion can be halide, such as chloride or bromide. In reaction of the above example with hexyl bromide, the quaternized nitrogen atom would have a bromide counterion unless it were subsequently exchanged.

### Description

In various embodiments, a composition of the instant invention comprises triblock copolymers comprising a functional triblock a purpose of which is to act as a non-leaching, non-toxic antimicrobial agent to prevent infection or fouling by airborne or liquid borne microbes. Optionally the composition may be include one or more additional non-functional triblock copolymers which can act as a base layer or matrix providing the mechanical properties desired for the coating, acting as a scaffold for the functional triblock copolymer.

The non-functional polymer may be chosen from Polystyrene-block-poly(ethylene-ran-butylene)-block-polystyene ABA triblock copolymers, Polystyrene-block-poly(ethylene-ran-propylene)-block-polystyene ABA triblock copolymers and Polystyrene-block-poly(ethylene-ran-butylene-ran-propylene)-block-polystyene ABA triblock copolymers. In one preferred embodiment this polymer is a Polystyrene-block-poly(ethylene-ran-butylene)-block-polystyene ABA triblock copolymer where the polystyrene blocks have a molecular weight between 4, 000 and 12,000 and the poly(ethylene-ran-butylene) block has a molecular weight between 25,000 and 200,000. The fraction of polystyrene in the block copolymer can vary from 8% to 27% by weight, preferably 9 to 20% and more preferably 10 to 15%.

In various embodiments, the invention provides a composition for a coating comprising a triblock copolymer having a functional block, wherein the functional block contains tertiary amino groups, wherein at least 10% of the tertiary amino groups are quaternized. For example, at least 50% of the tertiary amino groups can be quaternized. In various embodiments, the triblock copolymer can comprises a polystyrene block and a hydrogenated polydiene block. The triblock copolymer can also comprise a polyolefin block.

In various embodiments, the functional block of the triblock copolymer can comprise a reaction product of an epoxidized polyisoprene and a diamine wherein the diamine comprises a primary amino group and a tertiary amino group. For example, the diamine can be 3-(dimethylamino)-1-propylamine. Reaction of the primary amino group with the epoxide group of the epoxidized polyisoprene bringings about epoxide ring opening and formation of an aminoalcohol functionality on every reacted epoxidized monomeric unit. The tertiary amino group, pendant from the polymer backbone, can then be quaternized with an alkylating agent such as an alkyl or fluoroalkyl chloride or the like. In various embodiments, other epoxide groups of the triblock copolymer can be reacted with one or more polar, nonpolar and amphiphilic groups, to alter the physical properties of the copolymer. Accordingly, a triblock copolymer of the invention can comprise sidechains with tertiary amino groups, at least some of which are quaternized, and with sidechains comprising various polar, nonpolar, or amphipathic groups. Examples are provided below.

In various embodiments, the invention provides a composition of the invention comprising a triblock copolymer of formula (I)

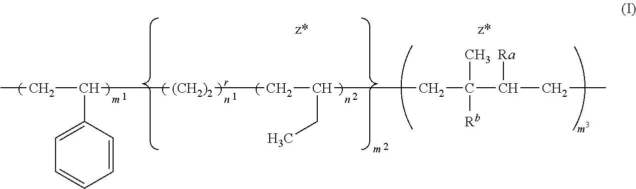

wherein

blocks m¹, m², and m³ can be disposed in any sequence;

a degree of polymerization of block m¹ is about 50 to about 120;

units n¹ and n² are selected so that block m² has a molecular weight of about 15,000 to about 100,000;

a degree of polymerization of m³ is about 75 to about 375;

r indicates that the arrangement of individual n¹ and n² units within block m² is random;

z* indicates that the orientation of individual n² units and units comprised by block m³ are reversible such that the ethyl side group may reside on either carbon of the n² unit, and R^{a} and R^{b} may reside on either of the internal carbons of the units of the m³ block;

in the units of block m³, R^{a} is OH, and at least some of R^{b} within block m³ contains a tertiary amino group wherein at least 10% of said tertiary amino groups are quaternized with one or more of quaternizing groups selected from the set consisting of:

(—CH₂)ₓ(—CF₂)_{y}—F wherein each x and y are independently 1 to 12,

(C₁-C₃₀) perfluoro alkyl groups,

(C₁-C₃₀) alkyl groups,

perfluoroalkyl group that contains one or more ethylene glycol groups,

alkyl group that contains one or more ethylene glycol groups, and

polydimethyl siloxane groups of molecular weight of <2,000;

and wherein remaining R^{b} within block m³ comprises one or more polar, nonpolar and amphiphilic groups selected from the set consisting of:

XCH₂CH₂ (OCH₂CH₂)ₙOCH₃ wherein each n is independently 1-16,

X(CH₂)ₓ(CF₂)_{y}F wherein each x and y are independently 2-16,

XCH₂CH₂ (OCH₂CH₂)_{q}(CF₂CF₂)ᵣF wherein each q is independently 0 to about 25 and each r is independently 0 to about 18,

XCH₂CH₂ (OCH₂OCH₂)ₙOC₆H₄(CH₂)ₙCH₃ wherein each n is independently 5-16,

XCH₂OCH₂ (OCH₂OCH₂)ₙ(CH₂)ₙ CH₃ wherein each n is independently 7-16, and

XCH₂OCH₂ (OCH₂OCH₂)ₙ(CH₂)₃Si(CH₃)(OSi(CH₃)₃)₂, wherein each n is independently 7-16; wherein X is a hetero atom.

A triblock copolymer of the invention can contain at least 10%, or at least 20%, or at least 50% of the R^{b} groups being a tertiary amino group, provided that at least 10% of said tertiary amino groups are quaternized. In various embodiments, at least 20%, or at least 50% of said tertiary amino groups are quaternized. In various embodiments, substantially all of the tertiary amino groups are quaternized. When a tertiary amino group is quaternized, there is a negatively charged counterion present. In various embodiments, a counterion for a quaternized amino group can be a halide ion, preferably a chloride or bromide ion.

Various alkylating agents can be used for quaternization of the tertiary amino group to produce an antimicrobial polymer of the invention. For example, a quaternizing group can be (—CH₂)ₓ(—CF₂)_{y}—F wherein each x and y are independently 1 to 12. Alternatively, a quaternizing group can be a semifluorinated hexylbromide (F8H6Br), or can be hexylbromide (H6Br). Copolymers of the invention include compositions wherein more than one quaternizing group is present, such as can be synthesized by use of mixed alkylating agents during the quaternization process.

In various embodiments, the invention provides a triblock copolymer where a polydiene block comprises polyisoprene, polybutadiene or a copolymer thereof, the hydrogenated polydiene block having a molecular weight of about 15,000 to about 200,000, and wherein the poly(styrene) block has a molecular weight of about 4,000 to about 12,000.

In various embodiments, the functional block copolymer can have a functional block comprising nonpolar side chains and/or polar chains in addition to the quaternary tertiary nitrogens. For example, the nonpolar side chains can be fluorinated or semifluorinated. For example, the polar side chains can be selected from polyethylene glycol, poly-3-hexyl thiophene, and zwitterionic chains. More specifically, the polar side chains are selected from the set consisting of:

(XCH₂CH₂)ₙOCH₃ wherein each n is independently 6-16;

X(CH₂)ₓ(CF₂)_{y}F wherein each x and y are independently 8-12;

(XCH₂CH₂)_{q}(CF₂CF₂)ᵣF wherein each q is independently 1 to about 25 and each r is independently 0 to about 18;

(XCH₂OCH₂)ₙOC₆H₄(CH₂)ₙCH₃ wherein each n is independently 8-16;

(XCH₂OCH₂)ₙ(CH₂)ₙCH₃ wherein each n is independently 8-16; and

(XCH₂OCH₂)ₙ(CH₂)₃Si(CH₃)(OSi(CH₃)₃)₂ wherein each n is independently 8-16.

In various embodiments, at least 1% of the side chains of a triblock copolymer of the invention are polar side chains selected from the set defined above.

In various embodiments, the invention provides an antimicrobial or antifouling coating comprising a composition of any of the invention. Such coatings can be applied to surfaces of various objects wherein control of microbial contamination is of concern to inhibit, for example, bacterial growth.

For example, the invention provides a process for preparing a coating from the composition of the invention, comprising dissolving the composition in a solvent to form a solution, then roll coating, curtain coating, solvent dipping, brushing, rolling or spraying the solution on a substrate, followed by removal of the solvent to form the coating on the substrate.

The coating can be a single layer of a triblock copolymer of the invention, optionally comprising in a mixture other polymers and copolymers suitable for the function of the coating. Alternatively, the invention also provides a multilayer coating comprising an adhesion layer comprising a functional polymer such as a maleated block copolymer and top layer of the composition of the invention. Or, the coating can comprise a self organizing, surface active polymer blend comprising a matrix triblock copolymer and one or more functional block copolymers of the invention, wherein the functional block copolymer is the minor component. The functional block copolymer is effective to inhibit the growth or attachment of microorganisms to the surface of the coating. For example, the functional triblock copolymer can be present at a level of at least 5% in the coating.

As described in the Examples and as within ordinary skill, a triblock copolymer of the invention can be synthesized. For example, the invention provides a method of preparing a triblock copolymer, comprising contacting triblock copolymer comprising an epoxidized polyisoprene and a diamine wherein the diamine comprises a primary amino group and a tertiary amino group to form an aminated triblock copolymer, followed by quaternization of at least 10% of tertiary amino groups comprised by the aminated triblock copolymer. For example, the diamine can be 3-(dimethylamino)-1-propylamine. The tertiary amino group of the incorporated diamine can then be quaternized with an alkyl or fluoroalkyl halide alkylating agent.

In various embodiments, the invention provides a method of inhibiting microbial growth on a surface, comprising coating the surface with the composition of the invention. For example, the coated surface can be disposed on a ship hull or other component in contact with an aqueous environment, wherein the coating inhibits the growth of marine organisms that might otherwise attach to the hull, etc. This coating can be less toxic to humans and non-microbial organisms than currently used marine coatings such as those containing copper or alkyl tins. Or, the coated surface can be disposed on a medical device or implant disposed within a living human body, wherein the coating inhibits the growth of bacteria on the surface of the implanted foreign body within living tissue, which otherwise could cause infection.

### EXAMPLES

### Materials

Perfluorooctyliodide and sodium bis(2-methoxyethoxy)aluminum hydride solution (Red-Al) were purchased from Fluka and used as received. 5-Hexen-1-ol, 2,2′-azobisisobutyronitrile (AIBN), sodium bis(2-methoxyethoxy)aluminum hydride, N,N-dimethylformamide (DMF), 1-methyl-2-pyrrolidinone (NMP), tetrahydrofuran (THF), methylene chloride, 3-(dimethylamino)-1-propylamine (DMAPA), and 1-bromohexane (H6Br) were purchased from Aldrich and used as received. Triphenylphosphine (TPP), carbon tetrabromide (CBr₄), potassium carbonate, and m-chloroperoxybenzoic acid (mCPBA) were purchased from Sigma-Aldrich. The polystyrene₈ₖ-block-poly(ethylene-ran-butylene)₂₅ₖ-block-polyisoprene₂₀ₖ, PS-b-P(E/B)-b-PI, triblock copolymer, with PS, P(E/B), and PI block molecular weights of 8 kDa, 25 kDa, and 20 kDa, respectively, was produced using anionic polymerization by Kraton Polymers. All other chemicals were purchased from Sigma-Aldrich and used without further purification.

### Example 1

### Synthesis of a Triblock Copolymer

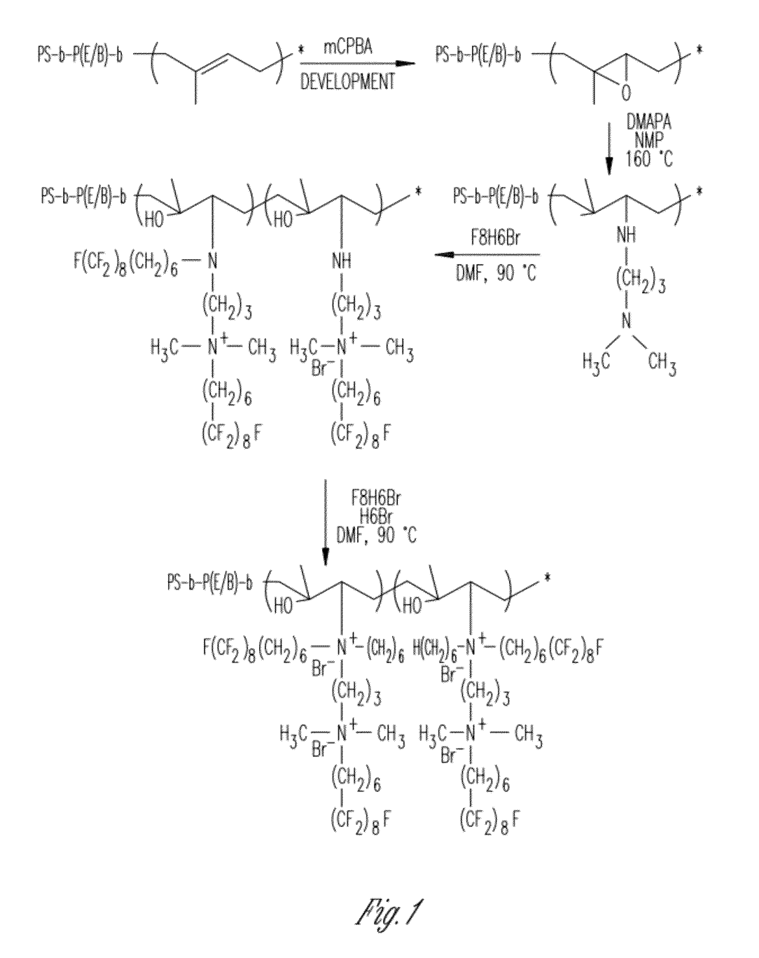

A functionalized SEBI triblock copolymer was prepared by the scheme shown in FIG. 1, below. The base SEBI was epoxidized, followed by reaction with 3-(dimethylamino)-1-propylamine. The amine functional polymer is then quaternized with F8H6Br. Unreacted amines are then further quaternized with H6Br.

### Synthesis of Semifluorinated Iodohexanol (F8H6IOH)

Perfluorooctyliodide (30 g, 55 mmol) and 5-hexen-1-ol (6.61 g, 66 mmol) were mixed in a 100 mL round bottom flask. AIBN (0.45 g, 2.75 mmol) was added and the reaction was performed for 2 hours at 80° C. under nitrogen atmosphere. The crude product was cooled to room temperature and semifluorinated iodohexanol (F8H6IOH) was recovered by crystallization in toluene/hexane (30/120 mL) mixture.

### Synthesis of Semifluorinated Hexanol (F8H6OH)

Sodium bis(2-methoxyethoxy)aluminum hydride solution (Red-Al, 19.8 g, 98.0 mmol) was dissolved in 160 mL of diethyl ether in a 500 mL round bottom flask. F8H6IOH (30 g, 46.4 mmol) was dissolved in 80 mL of diethyl ether and added to the Red-Al solution. The reaction was performed for 3 h at room temperature and then quenched with 200 mL of 2 M HCl solution. The organic phase was washed with 200 mL of brine, followed by drying with magnesium sulfate. The solution was concentrated under reduced pressure and the semifluorinated hexanol (F8H6OH) was recovered by further drying under reduced pressure for 24 h at room temperature.

### Synthesis of Semifluorinated Hexylbromide (F8H6Br)

F8H6OH (22.5 g, 43.3 mmol) and CBr₄ (23 g, 69.3 mmol) were dissolved in 100 mL of anhydrous THF in a 500 mL round bottom flask. The mixture was cooled to −5° C. Triphenyl phosphine (18.1 g, 69.3 mmol) was then added and the reaction was performed for 1 h at −5° C., followed by an additional 8 h at room temperature. The tetrahydrofuran was then evaporated under reduced pressure and 200 mL diethyl ether was added to the crude product. The triphenylphosphineoxide byproduct was separated by filtration, and the product was further purified by passing the reaction solution through a short silica gel column.

### Epoxidation of PS-b-P(E/B)-b-PI

PS-b-P(E/B)-b-PI, (10 g, 50 mmol of isoprene) was dissolved in 200 mL of methylene chloride in a 500 mL round bottom flask at room temperature. m-Chloroperoxybenzoic acid (mCPBA) (10.4 g, 60 mmol) was added, and the epoxidation was performed for 8 h at room temperature. About 80% of the reaction solvent was evaporated under reduced pressure and the epoxidized polymer was precipitated in excess methanol, filtered, dissolved in 30 mL of methylene chloride, re-precipitated in excess methanol, filtered, and dried under reduced pressure at room temperature for 48 h.

### Amination of Epoxidized PS-b-P(E/B)-b-PI

Epoxidized PS-b-P(E/B)-b-PI (1 g, 4 mmol of epoxy) was dissolved in 50 mL of NMP in a 300 mL round bottom flask at 90° C. DMAPA (12.3 g, 120 mmol) and TPP (0.2 g, 0.8 mmol) were added and the amination was performed for 48 h at 160° C. under reflux. The aminated block copolymer was precipitated in excess distilled water, filtered, dissolved in 50 mL of NMP, re-precipitated in excess distilled water, filtered, and dried under reduced pressure at room temperature for 48 h. Elemental analysis: C (76.9%), H (11.6%), O (5.49%), N (5.74%)

Quaternization of Aminated PS-b-P(E/B)-b-PI with Semifluorinated Hexylbromide (F8H6Br) and Hexylbromide (H6Br)

Aminated PS-b-P(E/B)-b-PI (0.4 g, 5.95 mmol of reactive amino and amine groups) was dissolved in 20 mL of DMF in a 100 mL round bottom flask at 90° C. F8H6Br (10.4 g, 17.9 mmol) and potassium carbonate (1.38 g, 10 mmol) were added to the reaction mixture. The flask was sealed with a rubber septum and the quaternization reaction was performed for 48 h at 90° C. under a nitrogen atmosphere. The residual amine groups were further quaternized with excess H6Br for 24 h at 90° C. Following completion of the second quarternization, about 80% of DMF was removed using a rotary evaporator at reduced pressure. The SQTCs were precipitated in excess diethyl ether, filtered, dissolved in 5 mL of DMF, re-precipitated in excess diethyl ether, filtered, and dried under reduced pressure at room temperature for 48 h. Elemental analysis: C (48.8%), H (5.6%), N (2.2%), F (35.3%) for first quaternization (SQTC-F8H6Br); C (50.1%), H (6.1%), N (1.6%), F (33.1%) for second quaternization (SQTC-F8H6Br—H6Br) Based on the NMR analysis (data is not shown) all double bonds from the isoprene block disappeared indicating 100% epoxidation. Using elemental analysis, it was determined that the aminated PS-b-P(E/B)-b-PI contained 5.7 wt % nitrogen content, corresponding to 59.6 mol % amination based on the 245 epoxy groups present in the epoxidized PS-b-P(E/B)-b-PI. The quaternization reaction with F8H6Br and H6Br resulted in the appearance of C—F stretching resonance at 1100-1300 cm⁻¹ indicating the attachment of semifluorinated groups.

### Example 2

A film was prepared from the product of Example 1. Multilayer surfaces for bioassays were prepared in a manner analogous to that reported in Krishnan et al (Krishnan et al. 2006). SEBS base layers were prepared in the manner previously described. The solutions of SQTCs in chloroform (1.5%, w/v) were spray-coated on the prepared SEBS-coated glass slides using a Badger 250 airbrush with 50 psi nitrogen gas flow. The surfaces were annealed under vacuum at 60° C. for 3 days, followed by an additional 12 h at 120° C.

### Example 3

### Antibacterial Tests

### Cell Growth

Trypticase Soy Broth (TSB, 5 mL; per liter: 3 g of soy meal peptone, 17 g of casein peptone, 2.5 g of glucose, 5 g of NaCl, and 2.5 g of dipotassium hydrogen phosphate) was inoculated with 100 μL of an overnight culture of S. aureus, and incubated at 37° C. for 4 h. The cells were centrifuged at 5000 rpm for 1 min using a microcentrifuge (Eppendorf 5415C), and the pellet was resuspended in 1 mL of sterile filtered water.

### Colony Counts

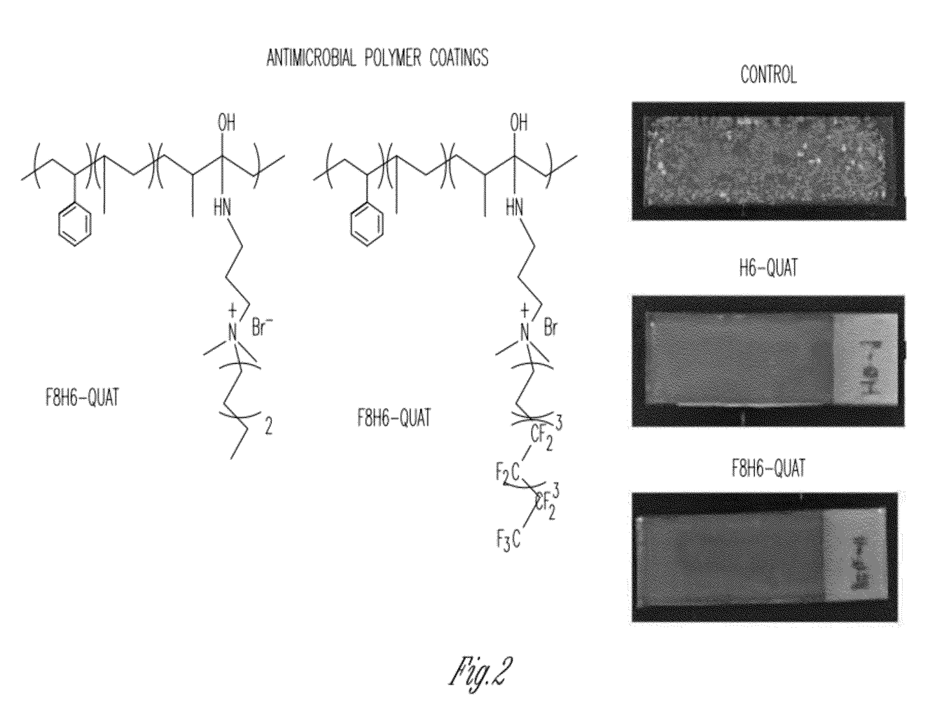

Aqueous suspensions of S. aureus with concentrations of ˜10⁶ cells/mL were sprayed on the test surfaces, dried in air for 2 min and placed in sterile Petri dishes. To control aerosols, spraying was performed in a class II type A biological safety cabinet (SterilGARD Hood, Baker Company) with a HEPA filter. The sprayed surfaces were covered by molten agar-containing TSB (1.5% w/v of agar), allowed to solidify and then incubated at 37° C. overnight. The number of bacterial colonies was counted using a colony counter. The mean value of bacterial colonies of S. aureus grown on plain glass slides after overnight incubation was ca. 125 colonies/cm². In contrast, no colonies formed on surfaces coated with SQTC-F8H6Br—H6Br, which indicates high antibacterial activity. See FIG. 2 for visual results.

### Example 4

An overnight broth culture of P. aeruginosa was centrifuged at approximately 3,000 rpm for 5 minutes, and the pellet was resuspended in PBS. After a second washing, the cells were suspended in PBS and applied to the surfaces of 2.5×7.5 cm coupons using a nebulizer.

Approximately 16 μL of the suspended cells were sprayed onto each coupon. Following 30, 60, and 120 minutes drying periods at ambient temperature, the inoculated coupons were overlaid with sterile tripticase soy agar cooled to 41-42° C. The solidified plates were incubated 48 hours (and observed at 24 hours) at 37° C., then assayed for colony counts under a dissecting microscope at up to 50× magnification. Apparent confluent growth on coupons was confirmed by removal of the agar overlay, Gram staining of the surface, then observation under 1,000× magnification.

Development of P. aeruginosa viable populations on the QAC polymer was contrasted with attachment to a control polymer coating that did not contain the QAC functionalities, glass slides that had been dip-coated with a 1% (w/v in deionized water) sodium azide solution (an antimicrobial), and untreated glass slides.

The inoculum used in the nebulizer was 5.0×10⁸ cfu/mL, and the approximate inoculums density applied to the slide surfaces was 4.3×10⁵ cfu/cm².

Confluent growth was observed on the control slides at 30 and 60 minutes, with reduced growth observed after 120 minutes. Similar results were observed for the untreated negative control slides (data not shown). No growth was seen on any of the treatment slides. Suspected confluent growth was confirmed by a Gram stain. No growth of the challenge organism was observed on the sodium azide positive control slides, or on uninoculated control (uncoated) slides. Some adventitious contamination was noted on several of the slides; however, the contamination was distinct from the P. aeruginosa inoculum.

### Example 5

### Materials and Methods

### Material Provided for Each Experiment

1. Fifteen polymer coated (control) 2.5×7.5 cm glass slides

2. Twenty-three QAC/polymer coated 2.5×7.5 cm glass slides

### Challenge (Bacterial) Organisms

Pseudomona aeruginosa (clinical strain), Staphylococcus aureus, or Escherichia coli

### Antimicrobial Surface Activity Assessment

This experiment measured the growth of the bacterial organisms on the QAC and control polymer substrata using an aerosol challenge protocol (Tiller, et al., 2001). The experiment was performed under aseptic conditions; however, the test materials were received in a non-sterile state. An overnight broth cultures of the bacteria were centrifuged at approximately 3,000 rpm for 5 minutes, and the pellet was re-suspended in PBS. After a second washing, the cells were suspended in PBS and applied to the surfaces of 2.5×7.5 cm coupons using a nebulizer. Approximately 16 μL of the suspended cells were sprayed onto each coupon. Following 30, 60, and 120 minutes drying periods at ambient temperature, the inoculated coupons were overlaid with sterile tripticase soy agar cooled to 41-42° C. The solidified plates were incubated 24, 48 and 72 hours (with interim observations) at 37° C., then assayed for colony counts under a dissecting microscope at up to 50× magnification. Apparent confluent growth on coupons was confirmed by removal of the agar overlay, Gram staining of the surface, then observation under 1,000× magnification.

Development of bacterial viable populations on the QAC polymer was contrasted with attachment to a control polymer coating that did not contain the QAC functionalities, glass slides that had been dip-coated with a 1% (w/v in deionized water) sodium azide solution (an antimicrobial), and untreated glass slides.

### Data Analysis

The colony counts were normalized to ‘cfu/cm², as a function of treatment and drying time. Results from the time course analysis were subjected to a one-way ANOVA with student-Newman-Keuls post testing using Graphpad InStat version 3.10 (GraphPad software, San Diego) to determine whether the QAC coating significantly affected bacterial adhesion. The inoculum used in the nebulizer was 5.0×10⁸ cfu/mL.

Confluent growth was observed on the control slides at 30 and 60 minutes, with reduced growth observed after 120 minutes. Similar results were observed for the untreated negative control slides (data not shown). No growth was seen on any of the treatment slides. Suspected confluent growth was confirmed by a Gram stain. No growth of the challenge organism was observed on the sodium azide positive control slides, or on uninoculated control (uncoated) slides. Some adventitious contamination was noted on several of the slides; however, the contamination was distinct from the inoculum.

TABLE 1
Bacterial Growth: Species versus polymer type

| | Quaternary | | Control polymer | | |
|---|---|---|---|---|---|
| | ammonium | | (no QATs | | Sodium azide |
| Organism | polymer type | Run time | attached) | QAT polymer | (—) control |
| P. aeruginosa | fluorinated chain | 48 hrs | 4.3 × 10⁵ cfu/cm² | 1.6 × 10¹ cfu/cm² | no growth |
| E. coli | hydrocarbon | 24 hrs | 3.9 × 10² cfu/inch² | 5.5 × 10⁴ cfu/inch² | no growth |
| | chain | | | | |
| E. coli | hydrocarbon | 48 hrs | 4.5 × 10⁵ cfu/inch² | 2.7 × 10⁵ cfu/inch² | no growth |
| | chain | | | | |
| E. coli | hydrocarbon | 72 hrs | 1.3 × 10⁵ cfu/inch² | 2.7 × 10⁴ cfu/inch² | no growth |
| | chain | | | | |
| S. aureus | hydrocarbon | 24 hrs | 9.4 × 10⁴ cfu/inch² | 8.0 × 10² cfu/inch² | no growth |
| | chain | | | | |
| S. aureus | hydrocarbon | 48 hrs | 1.0 × 10⁶ cfu/inch² | 2.2 × 10⁴ cfu/inch² | no growth |
| | chain | | | | |
| S. aureus | hydrocarbon | 72 hrs | 1.1 × 10⁵ cfu/inch² | 2.8 × 10⁴ cfu/inch² | no growth |
| | chain | | | | |

### REFERENCES

Tiller, J. C., C. J. Liao, K. Lewis and A. M. Klibanov. 2001. Designing surfaces that kill bacteria on contact. Proc Natl. Acad. Sci. USA 98(11): 5981-5985

All patents and publications referred to herein are incorporated by reference herein to the same extent as if each individual publication was specifically and individually indicated to be incorporated by reference in its entirety.

The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

What is claimed is:

1. A composition comprising a block copolymer having a functional block, wherein the functional block contains tertiary amino groups, wherein at least 10% of the tertiary amino groups are quaternized.

2. The composition of claim 1 where at least 50% of the tertiary amino groups are quaternized.

3. The composition of claim 1 wherein the block copolymer comprises a polystyrene block and a hydrogenated polydiene block.

4. The composition of claim 1 wherein the functional block comprises a reaction product of an epoxidized polyisoprene and a diamine wherein the diamine comprises a primary amino group and a tertiary amino group.

5. The composition of claim 4 wherein the diamine is 3-(dimethylamino)-1-propylamine.

6. The composition of claim 1 comprising a triblock copolymer of formula (I) 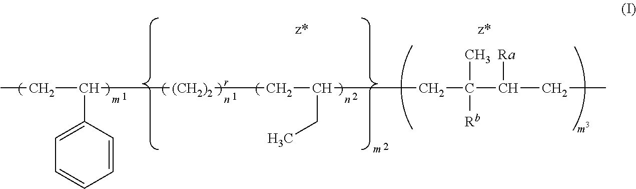
wherein
blocks m¹, m², and m³ can be disposed in any sequence;
a degree of polymerization of block m¹ is about 50 to about 120;
units n¹ and n² are selected so that block m² has a molecular weight of about 15,000 to about 100,000;
a degree of polymerization of m³ is about 75 to about 375;
r indicates that the arrangement of individual n¹ and n² units within block m² is random;
z* indicates that the orientation of individual n² units and units comprised by block m³ are reversible such that the ethyl side group may reside on either carbon of the n² unit, and R^{a} and R^{b} may reside on either of the internal carbons of the units of the m³ block;
in the units of block m³, R^{a} is —OH and at least some of R^{b} within block m³ contains a tertiary amino group wherein at least 10% of said tertiary amino groups are quaternized with one or more of quaternizing groups selected from the set consisting of:
(—CH₂)ₓ(—CF₂)_{y}—F wherein each x and y are independently 1 to 12,
(C₁-C₃₀) perfluoroalkyl groups,
(C₁-C₃₀) alkyl groups,
perfluoroalkyl group that contains one or more ethylene glycol groups,
alkyl group that contains one or more ethylene glycol groups, and
polydimethyl siloxane groups of molecular weight of <2,000;
and wherein remaining R^{b} within block m³ comprises one or more polar, nonpolar and amphiphilic groups selected from the set consisting of:
XCH₂CH₂ (OCH₂CH₂)ₙOCH₃ wherein each n is independently 1-16,
X(CH₂)ₓ(CF₂)_{y}F wherein each x and y are independently 2-16,
XCH₂CH₂ (OCH₂CH₂)_{q}(CF₂CF₂)ᵣF wherein each q is independently 0 to about 25 and each r is independently 0 to about 18,
XCH₂CH₂ (OCH₂OCH₂)ₙOC₆H₄(CH₂)ₙCH₃ wherein each n is independently 5-16,
XCH₂OCH₂ (OCH₂OCH₂)ₙ(CH₂)ₙ CH₃ wherein each n is independently 7-16, and
XCH₂OCH₂ (OCH₂OCH₂)ₙ(CH₂)₃Si(CH₃)(OSi(CH₃)₃)₂, wherein each n is independently 7-16; wherein X is a hetero atom.

7. The composition of claim 6 wherein at least 10%, or at least 20%, or at least 50% of R^{b} contains a tertiary amino group, at least 10% of said tertiary amino groups being quaternized.

8. The composition of claim 7 wherein at least 20%, or at least 50% of said tertiary amino groups are quaternized.

9. The composition of claim 6 wherein a counterion for a quaternized amino group is a halide ion.

10. The composition of claim 6 wherein the quaternizing group is (—CH₂)ₓ(—CF₂)_{y}—F wherein each x and y are independently 1 to 12.

11. The composition of claim 10 wherein the quaternizing group is a semifluorinated hexylbromide (F8H6Br).

12. The composition of claim 6 where the quaternizing agent is hexylbromide (H6Br).

13. The composition of claim 3 where the polydiene is polyisoprene, polybutadiene or a copolymer thereof, the hydrogenated polydiene block having a molecular weight of about 15,000 to about 200,000, and wherein the poly(styrene) block has a molecular weight of about 4,000 to about 12,000.

14. The composition of claim 1 where the functional block copolymer has a functional block comprising nonpolar side chains and/or polar chains in addition to the quaternary tertiary nitrogens.

15. The composition of claim 14 wherein the nonpolar side chains are fluorinated or semifluorinated.

16. The composition of claim 14 wherein the polar side chains are selected from polyethylene glycol, poly-3-hexyl thiophene, and zwitterionic chains.

17. The composition of claim 14 wherein the polar side chains are selected from the set consisting of:
(XCH₂CH₂)ₙOCH₃ wherein each n is independently 6-16;
X(CH₂)ₓ(CF₂)_{y}F wherein each x and y are independently 8-12;
(XCH₂CH₂)_{q}(CF₂CF₂)ᵣF wherein each q is independently 1 to about 25 and each r is independently 0 to about 18;
(XCH₂OCH₂)ₙOC₆H₄(CH₂)ₙCH₃ wherein each n is independently 8-16;
(XCH₂OCH₂)ₙ(CH₂)ₙCH₃ wherein each n is independently 8-16; and
(XCH₂OCH₂)ₙ(CH₂)₃Si(CH₃)(OSi(CH₃)₃)₂ wherein each n is independently 8-16.

18. The composition of claim 17 wherein at least 1% of the side chains are polar side chains selected from the set of claim 17.

19. An antimicrobial or antifouling coating comprising a composition of claim 1.

20. A process for preparing a coating from the composition of claim 1 comprising dissolving the composition in a solvent to form a solution, then roll coating, curtain coating, solvent dipping, brushing, rolling or spraying the solution on a substrate, followed by removal of the solvent to form the coating on the substrate.

21. A multilayer coating comprising an adhesion layer comprising a functional polymer such as a maleated block copolymer and top layer of the composition of claim 1.

22. The coating of claim 19 or 21 comprising a self organizing, surface active polymer blend comprising a matrix triblock copolymer and one or more functional block copolymers of claim 1, wherein the functional block copolymer is the minor component.

23. The coating of claim 22 wherein the functional block copolymer is effective to inhibit the growth or attachment of microorganisms to the surface of the coating.

24. The coating of claim 19 or 21 wherein the functional triblock copolymer is present at a level of at least 5% in the coating.

25. A method of preparing a triblock copolymer of claim 7 comprising contacting triblock copolymer comprising an epoxidized polyisoprene and a diamine wherein the diamine comprises a primary amino group and a tertiary amino group to form an aminated triblock copolymer, followed by quaternization of at least 10% of tertiary amino groups comprised by the aminated triblock copolymer.

26. The method of claim 25 wherein the diamine is 3-(dimethylamino)-1-propylamine.

27. A method of inhibiting microbial growth on a surface, comprising coating the surface with the composition of claim 1.

28. The method of claim 27 wherein the surface is disposed on a ship hull or other component in contact with an aqueous environment.

29. The method of claim 27 wherein the surface is disposed on a medical device or implant disposed within a living human body.

30. The method of claim 28 wherein the composition is less damaging to the aqueous environment than an antifouling composition comprising copper or tin compounds.
